(19) United States
(12) Patent Application Publication
(10) Pub. No.: US 2008/0306928 A1
(43) Pub. Date: Dec. 11, 2008

(54) METHOD AND APPARATUS FOR THE SEARCHING OF INFORMATION RESOURCES

(75) Inventors: JEAN-SEBASTIEN BRUNNER, ISSY-LES-MOULINEAUX (FR); LI MA, BEIJING (CN); YUE PAN, BEIJING (CN); LEI ZHANG, SHANGHAI (CN)

Correspondence Address: SHIMOKAJI & ASSOCIATES, P.C., 8911 RESEARCH DRIVE, IRVINE, CA, 92618, US

(73) Assignee: INTERNATIONAL BUSINESS MACHINES CORPORATION, Armonk, NY (US)

(21) Appl. No.: 12/111,898

(22) Filed: Apr. 29, 2008

(30) Foreign Application Priority Data
Jun. 11, 2007 (CN) 200710108983.0

(51) Int. Cl. G06F 17/30

(52) U.S. Cl. 707/4; 707/E17.014

(57) ABSTRACT

The present invention discloses a method and apparatus for the searching of information resources. A method includes steps of: according to a current query for a first type of information resource, obtaining a result of query on said first type of information resource, one or more facets of said first type of information resource and metadata under each facet, and relationships between said first type of information resource and other types of information resource that at least include a second type of information resource; and returning to a user the obtained result of query on said first type of information resource, the one or more facets of said first type of information resource and the metadata under each facet, and the relationships between said first type of information resource and other types of information resource that at least include a second type of information resource.

### CROSS REFERENCE TO RELATED APPLICATIONS

This application claims the benefit of Chinese Patent Application No. 200710108983.0 filed Jun. 11, 2007, which is incorporated by reference.

### BACKGROUND OF THE INVENTION

The present invention relates to the field of information technology, and more particularly, to a method and apparatus for the searching of information resources.

Traditional text-based search is widely used for searching information resources (e.g. BOOK, AUTOMOBILE, COMPANY, etc). However, keywords specified by a user might not match data describing information resources although they might have the same meaning. Thus, users have to guess the corresponding keywords in order to find desired results.

Hierarchical navigation organizes information resources in a tree-like structure and facilitates users to navigate specific information resources. On the website http://dir.yahoo.com, for example, information resources are organized in the tree-like structure. However, users might have a different view with respect to how the information resources can be organized hierarchically and are possibly uncomfortable with the provided hierarchy. This might lead users to dead ends during navigating.

Recently, a solution named “faceted search” has been proposed for searching or navigating information resources. For example, U.S. Pat. No. 7,146,362 B2, which is hereby incorporated by reference, discloses a solution for facilitating users to navigate information resources by displaying to users respective facets of information resources and metadata under each facet.

In this faceted search solution, a faceted search engine automatically displays to a user respective facets of a type of information resource and metadata under each facet, in order to enable the user to further refine the current query and provide to the user a holistic picture about the type of information resource. This helps the user understand the type of information resource and thus better refine his/her query to obtain what he/she wants.

For example, when searching for a book, the faceted search engine might display the respective facets of BOOK, such as subject, author, publication time, and publisher and metadata under each of these facets. Through the metadata, a user can refine his/her query. For example, the user can choose the metadata under such a facet as the author (e.g., the author's name), which is displayed by the faceted search engine, to find all books written by the author.

Standard faceted search, however, can not well address a search that involves different types of information resources. For example, consider the search “books that were written by Asian authors under 30.” The relationship “written by” here connects two different types of information resource: BOOK and AUTHOR. The faceted search engine will display a list of facets of BOOK (such as subject, author, publisher and price) and metadata under each facet but does not display facets of AUTHOR (e.g. age, citizenship) and metadata under each facet. Therefore, users cannot use the metadata under facets of AUTHOR to search for desired books.

One might think that the facets of AUTHOR can be treated as facets of BOOK so that users can use the metadata under facets of AUTHOR to search for books. This actually is not feasible.

For example, consider the search “books that were written by authors under 30 who work for a public company headquartered in US”. In an implementation shown in FIG. 1, facets of other types of information resources are treated as the facets of BOOK. For example, facets of AUTHOR (citizenship, age, etc.) and facets of COMPANY (type, in-industry, headquartered-in, etc.) are regarded as facets of BOOK. Therefore, as shown in FIG. 1, in this implementation facets of BOOK comprise the publisher facet, the author-citizenship facet, the author-age facet, the author-works-for-company-type facet, the publication time facet, the author-works-for-company-in-industry facet, the author-works-for-company-headquartered-in facet, and the price facet.

This implementation actually enumerates part of possible facets of some possible types of information resource connected via relationship(s) to BOOK.

This implementation, however, is not scalable. The maximum of the increased number of facets equals the number of all possible facets of all other types of information resource connected via relationship(s) to the current type of information resource.

For example, in the aforesaid implementation, if the relationship “published by” is considered, then in FIG. 1 there are further comprised respective facets of PUBLISHER, e.g., the publisher-type facet, the publisher-headquartered-in facet, and the publisher-published books-in-industry facet, as shown in FIG. 2.

When the query becomes more and more complicated, i.e., when types of information resource are connected with many relationships, the increased number of facets will be huge. Users will become confused when facing such a huge number of facets. In addition, it is hard to reduce the number of facets because the relationship the user is interested in cannot be known in advance. For example, is it the “published by” relationship or the “written by” relationship the user is interested in?

Moreover, one might think that the facets of AUTHOR can be treated as the metadata of author. Specifically, the facets of AUTHOR and facets of other types of information resources (e.g., Company) connected via relationship(s) to AUTHOR can be treated as the metadata of author. This also is not feasible. When the query becomes more and more complicated, the facets of AUTHOR will become more complicated.

### SUMMARY OF THE INVENTION

According to one embodiment of the present invention, a method for the searching of information resources comprises the steps of: according to a current query for a first type of information resource, obtaining a result of query on said first type of information resource, one or more facets of said first type of information resource and metadata under each facet, and relationships between said first type of information resource and other types of information resource that at least include a second type of information resource; and returning to a user the obtained result of query on said first type of information resource, the one or more facets of said first type of information resource and the metadata under each facet, and the relationships between said first type of information resource and other types of information resource that at least include a second type of information resource.

According to another embodiment of the present invention, an apparatus for the searching of information resources comprises: means for, according to a current query for a first type of information resource, obtaining a result of query on said first type of information resource, one or more facets of said first type of information resource and metadata under each facet, and relationships between said first type of information resource and other types of information resource that at least include a second type of information resource; and means for returning to a user the obtained result of query on said first type of information resource, the one or more facets of said first type of information resource and the metadata under each facet, and the relationships between said first type of information resource and other types of information resource that at least include a second type of information resource.

These and other features, aspects and advantages of the present invention will become better understood with reference to the following drawings, description and claims.

### BRIEF DESCRIPTION OF THE DRAWINGS

FIG. 1 shows an implementation that is not scalable and that might be employed for search traversing different types of information resource;

FIG. 2 shows facets that need to be included into FIG. 1 if one more relationship is taken into account according to the implementation of FIG. 1;

FIG. 3 shows a system 300 in which the present invention can be implemented;

FIG. 4 shows a window shown on a client;

FIG. 5 shows a two-level window shown on the client

FIG. 6 shows a three-level window shown on the client;

FIG. 7 is a flowchart of a method for the searching of information resource that is performed on a server; and

FIG. 8 shows a design of a table schema of a database.

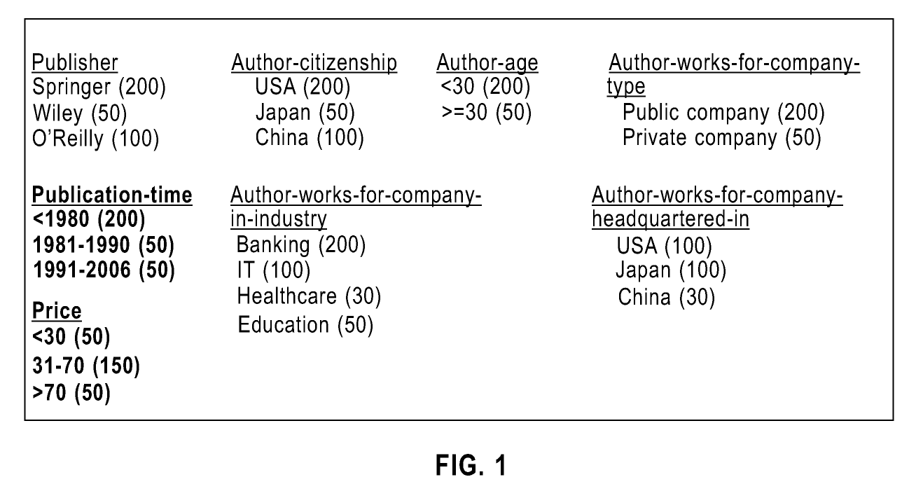

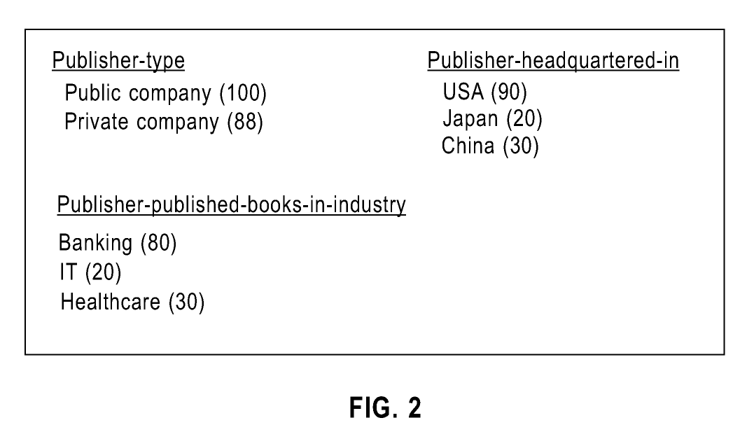

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, embodiments of the present invention provide a method and apparatus for the searching of information resources, with which users can find needed information with ease. According to the present invention, a user can perform complicated information resource searching and navigation in a simple way.

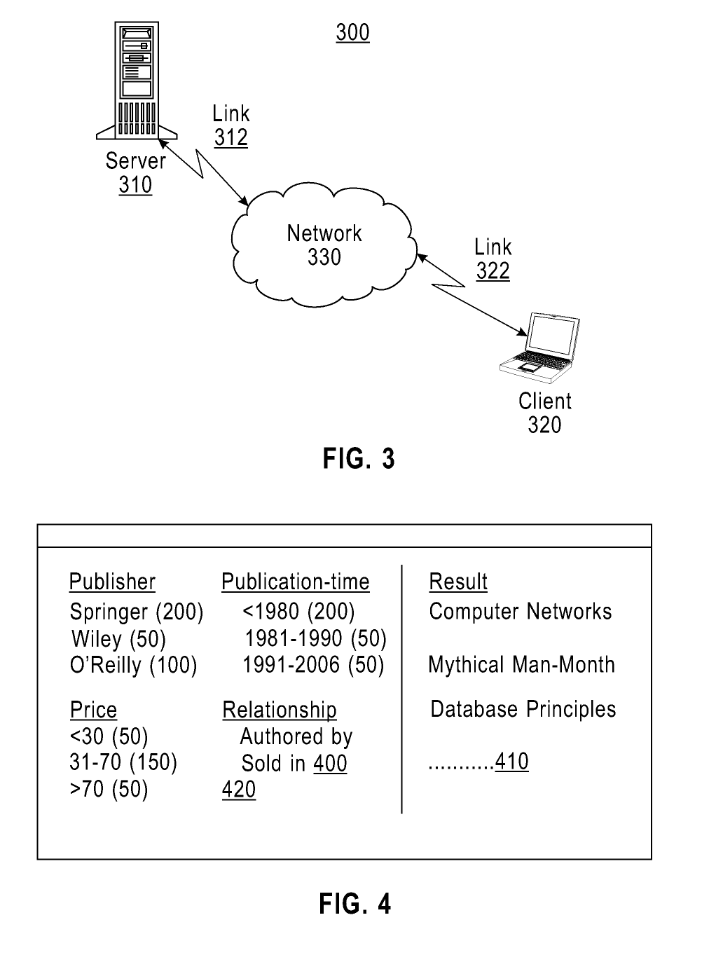

FIG. 3 shows a system 300 in which the present invention can be implemented. As shown in FIG. 3, system 300 may comprise a server 310, a client 320 and a network 330. Each of server 310 and client 320 can be, for example, a laptop computer, a minicomputer, or a middle computer. Server 310 may be connected via a link 312 to network 330; and client 320 may be connected via a link 322 to network 330. Links 312 and 322 can be wired links—such as coaxial cables or optical fibers, for example—or wireless links—such as satellite links. Likewise, network 330 can be a wireless network, a wired network, or a combination of different types of networks. Furthermore, network 330 can be a local area network, a metropolitan area network, or a wide area network. For example, network 330 may be the internet.

Of course, those skilled in the art may understand that other clients and servers can be connected on network 330. Moreover, in order to be distinguished from one another, the clients and servers can have identifiers capable of identifying them uniquely—such as IP addresses and universal resource locators (URLs), for example.

Additionally, a client application may be installed on client 320, and a search engine may reside on server 310.

Hereinafter, the present invention will be described in terms of client 320 and server 310 and, more specifically, in terms of the client application and the search engine. The target information resources to be searched by users may be constrained by a fixed data model or schema that may be a database schema or UML (unified modeling language) model.

For example, a given type of information resource may have a fixed number of attributes (i.e. facets) and a fixed number of possible relationships to other types of information resources. The target information resources, however, may not also be constrained by a fixed data model or schema. For example, the target information resources may be a data set conforming to the W3C RDF and OWL specification (Graham Klyne and Jeremy Carroll, editors, Resource Description Framework (RDF): Concepts and Abstract Syntax, W3C Recommendation, Feb. 10, 2004; Peter F. Patel-Schneider, Patrick Hayes and Ian Horrocks, editors, OWL Web Ontology Language Semantics and Abstract Syntax, W3C Recommendation, Feb. 10, 2004), in which any type of information resource can have any attributes and any relationships to any other types of information resources.

### Interaction Occurring on Client

Still referring to FIG. 3, the interaction occurring on the client 320 may be as follows.

When a user needs to search a type of information resource, he/she may start a client application on client 320 and input into the client application a type of information resource he/she desires to search, to access the search engine on server 310.

After the user inputs into the client application the type of information resource (a first type of information resource) he/she may desire to search—“BOOK”, for example—and clicks the “search” button on the client application; a new window 400 may be generated on client 320, as shown in FIG. 4.

As shown in FIG. 4, in addition to search results (the result column), what is displayed in window 400 may include applicable facets of current search results of such a type of information resource—for the BOOK example: publisher, publication time, price and metadata under these facets. Most importantly, included may be relationships to connect current search results of such a type of information resource—e.g., BOOK—to other types of information resource. Here, the relationships may comprise “authored by” and “sold in.” In other words, other types of information resources may comprise AUTHOR, BOOKSTORE, or the like.

In FIG. 4, metadata under some facets—price facet, for example—may be ranges.

It should be noted that the figure in the parentheses on the right side of the metadata under each facet denotes the number of instance of this type of information resource under the metadata. For example, FIG. 4 shows there are 200 books that meet the current search condition and that were published by publisher Springer.

Metadata under all facets and relationships may be highlighted in some way (e.g. colored) and may be clickable.

After a user sees on client 320 window 400, as shown in FIG. 4, he/she can choose metadata under a certain facet or a relationship by clicking a mouse.

For example, if the user wishes to search books published by publisher Springer, then he/she can click the Springer metadata under the publisher facet. Then, the window as shown in FIG. 4 may be changed. More specifically, contents shown in result column 410, which are titles of books published by publisher Springer, may be changed. Additionally, facets shown in facet column 420 also may be changed. For example, the publisher facet may no longer be shown, and metadata under other facets, for example, metadata under the publication time facet may also be changed. For the purpose of succinctness, titles only of books are shown in the result column 410. Those skilled in the art may understand that other information of books—such as price or publication time, for example—can also be shown in the result column 410.

If, however, the user wishes to search books authored by a specific author (a second type of information resource), then he/she can click the relationship “authored by”.

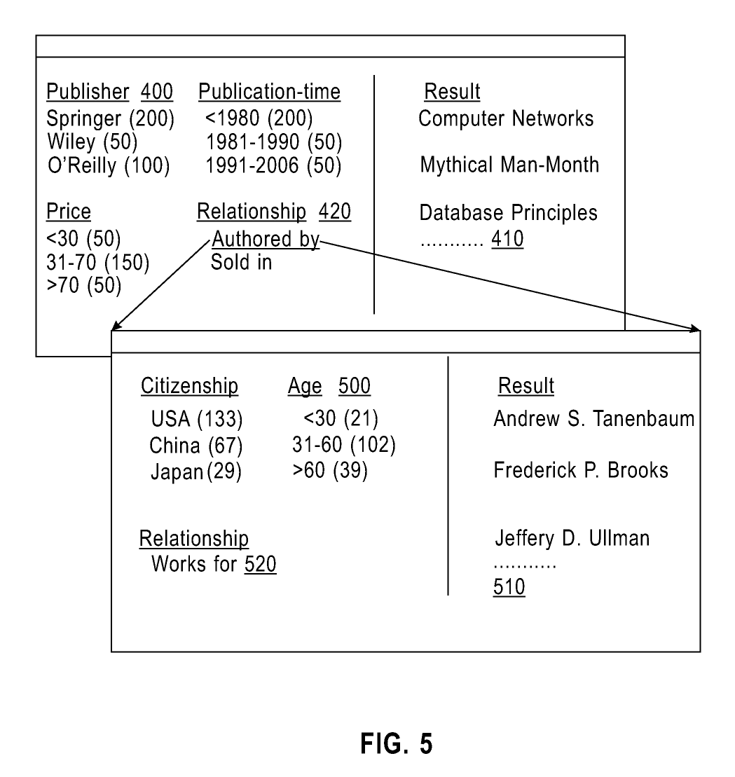

After the user clicks the relationship “authored by” on facet column 420, as shown in FIG. 4, a new window, e.g., a window 500, as shown in the lower part of FIG. 5, may be generated.

In window 500 there are shown authors (in result column 510 on the right) of the books in window 400 and applicable facets of these authors, e.g., citizenship, age or the like, metadata under these facets, and most importantly, relationships to connect a type of information resource—such as AUTHOR—to other types of information resource (as shown in facet column 520). Here, the relationship comprises “works for” and the other type of information resource comprises COMPANY.

At this point, not only metadata under all facets and relationship in facet column 520 of window 500 shown in FIG. 5 may be highlighted in some way (e.g. colored) and clickable, but also names of authors in result column 510 may be highlighted in some way (e.g. colored) and clickable.

The user can perform standard faceted search on AUTHOR in facet column 520 of window 500 shown in FIG. 5. For example, if the user wishes to search USA authors, then he/she can click the USA metadata under the citizenship facet. Afterwards, contents shown in result column 510 of window 500 in FIG. 5 may be changed. For the sake of brevity in illustration, only names of USA authors are shown. Additionally, contents shown in facet column 520 of window 500 may also be changed. For example, the citizenship facet may no longer be shown, and metadata under other facets—such as metadata under the age facet—may be changed as well.

If, however, the user wishes to search authors working for a specific company (a third type of information resource), then he/she can click the relationship “works for”.

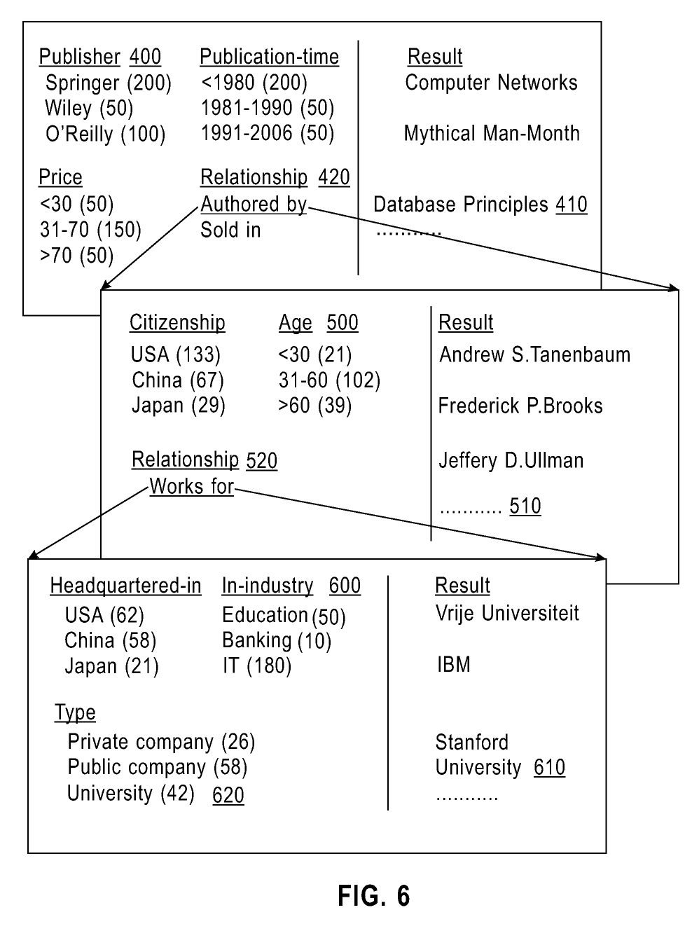

After the user clicks the relationship “works for” in facet column 520 of window 500, a new window 600 may be generated, e.g., the window as shown in the lowermost part of FIG. 6.

In window 600, names of companies (as shown in result column 610) of the authors in result column 510 of window 500 and applicable facets of these companies—e.g., headquartered-in, in-industry, type or the like—as well as metadata under these facets (as shown in facet column 620) may be shown. In this implementation, a type of information resource—such as COMPANY—may have no relationship to other types of information resource.

At this point, not only metadata under all facets in facet column 620 of window 600 may be highlighted in some way (e.g. colored) and clickable, but also names of companies in result column 610 may be highlighted in some way (e.g. colored) and clickable.

The user can perform standard faceted search on, for example, COMPANY in facet column 620. For example, if the user wishes to search companies headquartered in USA, then he/she can click the USA metadata under the headquartered-in facet. Afterwards, contents shown in result column 610 of window 600 may be changed. For the sake of illustration, only names of companies headquartered in USA are shown. Additionally, facets in facet column 620 may also be changed. For example, the headquartered-in facet may no longer be shown, and metadata under other facets—such as the metadata under in-industry facet—may be changed as well.

When the user is satisfied with results in a window, he/she can simply close the window. After the window is closed, contents shown in result column (such as result column 410 or 510) of upper-level window of this window may be changed. For the sake of illustration, only results corresponding to the metadata under a certain facet which the user has chosen in the closed window are shown.

For example, if the user wishes to search books authored by authors working for companies headquartered in USA, after the user clicks the “USA” metadata under the “headquartered-in” facet in window 620 of FIG. 6, he/she closes window 600 shown in FIG. 6. Then, contents shown in result column 510 of window 500 above window 600 shown in FIG. 6 may be changed. For the sake of illustration, only names of authors who work for USA-headquartered companies are shown.

Similarly, after window 500 is closed, contents shown in result column 410 of window 400 above window 500 may also be changed. For the sake of illustration, only titles of books authored by authors who work for USA-headquartered companies are shown.

In an embodiment of the present invention, before a window is closed, the user cannot operate this window's upper-level window. More specifically, referring to FIG. 6, before window 600 is closed, the user cannot operate window 500. Likewise, before window 500 is closed, the user cannot operate window 400. In most Windows operating systems, this can be implemented by specifying the window type to be child modal window or the like when creating a new window.

Each window can be closed by clicking the button “OK” (not shown) on the window or by clicking the X-type close button on the window title bar. Those skilled in the art may understand that there can be a variety of possible implementations to close a window.

Of course, in the embodiments of the present invention, after a window is closed and contents shown on its upper level window are changed, the user can perform standard faceted search in the facet column of its upper-level window, e.g., click metadata under the age facet using a mouse.

### Steps Performed on Server

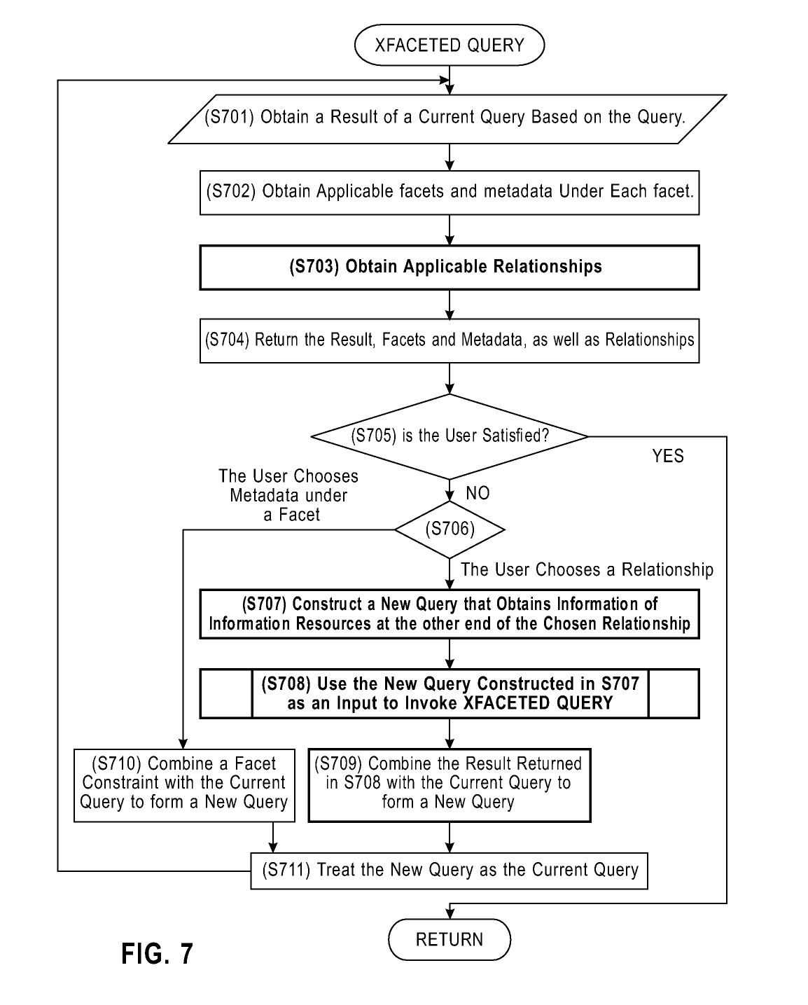

FIG. 7 shows steps that may be performed by server 310, more specifically, by the search engine in server 310.

First, in step S701, according to the user's current query, the search engine may obtain a result of query.

Then, in step S702, the search engine may obtain applicable facets and metadata under each facet that can be suggested to the user.

In step S703, the search engine may obtain applicable relationships that can be suggested to the user.

In step S704, the search engine may return the result of query which was obtained in step S701, the applicable facets and the metadata under each facet which were obtained in step S702, and the applicable relationships which were obtained in step S703 to client 320, more specifically, to the client application on client 320.

In step S705, the search engine may determine whether or not the user is satisfied with the information provided in step S704. For example, when the user clicks the button “OK” on the window, the search engine may determine that the user is satisfied with the information provided in step S704. If the user clicks metadata under the applicable facets or the applicable relationships provided in step S704, then the search engine may determine that the user is not satisfied with the information provided in step S704.

In step S706, the search engine may determine whether the user chooses (clicks) metadata under a facet or a relationship.

When the search engine determines that the user has chosen metadata, the flow goes to step S710 in which the search engine combines such constraint as metadata under a certain facet the user has chosen with the current query received in step S701 to form a new query. And in step S711, the new query may be treated as the current query. Then, the flow returns to step S701.

When the search engine determines that the user has chosen a relationship, the flow goes to step S707. In this step, the search engine may construct a new query that causes the obtained information to comprise information of a type of information resource at the other end of the chosen relationship, e.g., facets of this type of information resource, metadata under each facet, and most importantly, relationships to connect this type of information resource to other types of information resource. Moreover, as to be described below, the new query may be based on the current query described in step S701. In step S708, steps described in FIG. 7, including the steps described previously and those to be described below, may be recursively invoked using the new query. Here, all the steps shown in FIG. 7 are denoted by XFACETED QUERY.

The condition for exiting the recursive invocation may be determined in step S705 that the user is satisfied with the provided information and thus has clicked the button “OK” on a window to close this window.

After exiting the recursive invocation, in step S709, the search engine may combine the current query with the query that leads to a result returned in the recursive step S708 to form a new query. And in step S711, the new query may be treated as the current query. Then, the flow returns to step S701.

Here, “return” means not only the end of the whole search procedure but also the exit of the recursive invocation. More specifically, when the user is satisfied with the returned information and has clicked the button “OK” on the window using a mouse, either the whole search procedure ends or a level of recursive invocation exits.

The aforesaid steps can be performed by means of performing corresponding steps respectively. For example, obtaining means obtains a result of query, applicable facets and metadata under each facet as well as applicable relationships; returning means returns the obtained result of query, the obtained applicable facets and metadata under each facet as well as the obtained applicable relationships; determining means determines whether the user has chosen metadata or a relationship or satisfied with the result; combining means combines the current query with metadata or the result the user has chosen to form a new query; value assigning means treats the new query as the current query; and constructing means constructs a new query for obtaining information of a type of information resource at the other end of the chosen relationship, and so on.

Hereinafter, respective descriptions will be given to a concrete implementation performed by the search engine for the aforesaid steps when the target information resources are constrained by a fixed data model or schema and a concrete implementation performed by the search engine for the aforesaid steps when the target information resources are not constrained by a fixed data model or schema.

### Constrained by Data Model or Schema

In this case, every type of information resource has a fixed number of attributes (facets) and relationships. Here, a database schema and SQL may serve as an example. Of course, those skilled in the art can understand that other models or schemas (e.g. UML model, XML schema) and other languages may be feasible. It should be noted that the following implementation is a straightforward example and is not optimized. Those skilled in the art can develop more optimized implementations based on what is disclosed here.

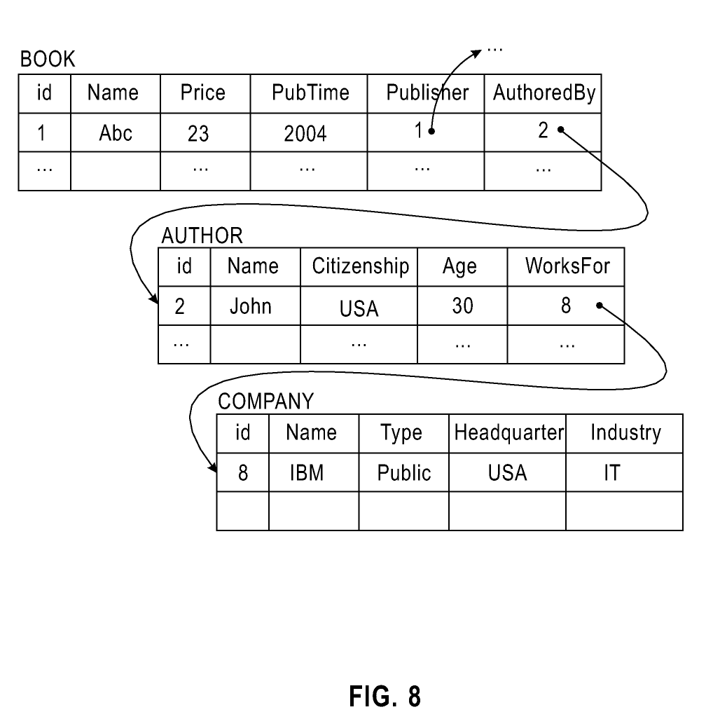

Still using BOOK, AUTHOR and COMPANY as an example, the database schema as shown in FIG. 8 can be used to define and store information on books (BOOK), authors (AUTHOR) and companies (COMPANY).

Every type of information resource may be stored in one table (T) in which one line represents one instance of this type of information resource. Values of attributes (facet metadata) of the type of information resource may be stored as values in columns of the table and relationships may be stored in columns of the table as foreign keys pointing to other types of information resource. The database schema defines how many possible attributes (facets) or relationships with other types of information resource a type of information resource can have. If a specific instance of the type of information resource does not have the attribute or relationship in an aspect, then the value of the attribute or relationship column in this aspect of the instance may be a NULL value.

As described previously, when a user needs to search a type of information resource, he/she may start a client application on client 320, input into the client application a type of information resource he/she wants to search, and click the button “search” on the client application to access the search engine on server 310.

Here, suppose the type of information resource which the user inputs into the client application and which he/she wants to search for is “BOOK”.

For step S701, the search engine may constructs a SQL statement S that selects all information resource instance IDs of that type of information resource—for example, S=“SELECT id FROM BOOK”. Then, the search engine may execute the SQL statement S to obtain an initial result.

For step S702, suppose applicable facets and metadata under each facet can be obtained by some method, e.g., by reading a file that stores all the pre-defined facet definitions for the current type of information resource (each facet definition consisting of a facet name and metadata under the facet) or by treating every attribute as a facet and scanning all the values in an attribute column. For example, price and publication time are facets of BOOK, they are from the “price” and “publication time” attribute columns of the BOOK table in the database. For the price facet, its metadata may be ranges, such as “<30,” “30-70” and “>70”.

For step S703, since the data model is fixed, all possible relationships of the current type of information resource can be known in advance, e.g., all the foreign key columns in the table. All these possible relationships can be suggested to the user. In an exemplary embodiment, those relationships that have non-NULL values with respect to the current query S may be suggested to the user. That is to say, if the following query:

SELECT count(id) FROM T
WHERE REL != NULL AND id in (S)

returns non-zero count, then the relationship REL may be suggested to the user.

For step S704, as described previously, since the current query S selects IDs of the type of information resource which the user is interested in, which is not visual, one or more comparatively visual attribute values (e.g. names) of the type of information resource may be obtained as the result of query.

For example, the following query:

SELECT name FROM T
WHERE id in (S)

may be used to select the names of the type of information resource as result of query.

As described previously, in this step S704, applicable facets, metadata under each facet and relationships may be shown to the user.

For step S710, the search engine may combine the facet metadata constraint which the user has chosen with the current query S to form a new query S′. Here, for example, a facet metadata constraint can be a range constraint (e.g. >, =, <) on attribute column values. The new constraint can be added to the WHERE clause of the query S (if there is no WHERE clause, one can be added). Suppose the current query S is in the form of:
SELECT . . . FROM . . . WHERE . . . ,
   the new query S′ then may be:
SELECT . . . FROM . . . WHERE . . . AND new_constraint.

This step S710 may also be a step in standard faceted search. As an example, suppose the user selects the metadata constraint “<30” under the price facet under the current query S:
SELECT id FROM BOOK,
   then the new query S′ may be:
SELECT id FROM BOOK WHERE Price<30.

After the user selects the metadata constraint “<1980” under the publication time facet, the query may further change to:
SELECT id FROM BOOK WHERE Price<30 AND publication time<1980.

For step S707, given the current query S and the user selected relationship REL that is associated with a table T′, the search engine may construct a new query S′ that leads to information resource instances in the table T′ that may be connected to S via REL:

SELECT T’.id FROM T, T’
WHERE T’.id = T.REL AND T.id in (S).

For example, if the current query S is:
SELECT id FROM BOOK WHERE Price<30,
   after the user selects the “AuthoredBy” relationship, the new query S′ may become:

SELECT AUTHOR.id FROM BOOK, AUTHOR
WHERE AUTHOR.id = BOOK.AuthoredBy AND
BOOK.id in (SELECT id FROM BOOK WHERE Price<30).

For step S708, the new query S′ constructed in step S707 may be input to recursively invoke XFACTED QUERY.

For step S709, according to the current query S, the relationship REL that the user has selected, and the result R returned from step S708, the search engine may construct a new query S′ that uses R to further constrain S. Suppose S is:
SELECT T.id FROM . . . WHERE . . . ,
   then S′ may be:
SELECT T.id FROM . . . WHERE . . . AND T.REL in (R).
   As an example, suppose the current query S is:
SELECT id FROM BOOK WHERE Price<30,
   and the result R returned from step S708 is a result of the following query:

```
    SELECT AUTHOR.id FROM BOOK, AUTHOR
    WHERE AUTHOR.id = BOOK.AuthoredBy AND BOOK.id in
(SELECT id FROM BOOK WHERE Price<30 ) AND Age<30,
```

then S′ may be:

SELECT id FROM BOOK WHERE Price<30 AND AuthoredBy in
(
SELECT AUTHOR.id FROM BOOK, AUTHOR
WHERE AUTHOR.id = BOOK.AuthoredBy AND BOOK.id in
(SELECT id FROM BOOK WHERE Price<30) AND Age<30
).

For step S711, the search engine may simply use the new query constructed in either step S709 or step S710 to replace the current query. In other words, the search engine may set S=S′.

### Not Constrained by Data Model or Schema

Here, it may be assumed that the target information resources to be navigated or searched by users are not constrained by a fixed data model or schema. One type of information resource can have any attributes and relationships. All types of information resource together can be seen as a network where the node is a type of information resource and the edge is a relationship between two types of information resource.

Here, a data set in RDF (Resource Description Frame) format and SPARQL (Simple Protocol and RDF Query Language) query language (Eric Prud'hommeaux and Andy Seaborne, SPARQL query language for RDF, W3C Working Draft, October, 2006) may serve as an example. In RDF, every type of information resource may be identified by a URL. Here, the notation such as ex:book may be used to write a URL (uniform resource locator).

Here, suppose the user wishes to search all books. Therefore, for step S701, the search engine may execute the following SPARQL S:
SELECT ?b WHERE {?b rdf:type ex:Book}.

For step S702, suppose the applicable facets and metadata under each facet can be obtained by some method, e.g., by reading a file that stores all the pre-defined facet definitions (each facet definition consisting of a facet name and metadata under the facet) of the current type of information resource.

For step S703, a SPARQL query can be constructed based on the current query S, and the SPARQL query can be used to obtain applicable relationships for the current type of information resource.

If the current query S is:
SELECT ?x WHERE { . . . },
   then the query to obtain the applicable relationships can be constructed as:

SELECT ?p WHERE { ?x ?p ?z . ?p rdf:type
owl:ObjectProperty . ...}, in which ?z is a variable not in S.

For example, if the current query S is:
SELECT ?b WHERE {?b rdf:type ex:Book},
   then the query to obtain the applicable relationships may be:

SELECT ?p
WHERE
{?b ?p ?z . ?p rdf:type owl:ObjectProperty . ?b rdf:type ex:Book }.

For step S704, the result of the current query S might be not visual. Then, one or more comparatively visual attribute values (e.g., name) of this type of information resource can be obtained as a result of query.

Since the current query S is:
SELECT ?x WHERE { . . . },
   based on this query, a new query can be constructed to obtain values of some attribute (e.g., ex:attr) of ?x:
SELECT ?v WHERE {?x ex:attr ?v . . . }.

For example, if the current query S is:
SELECT ?b WHERE {?b rdf:type ex:Book},
   then the following query:
SELECT ?v WHERE {?b dc:title ?v. ?b rdf:type ex:Book}
   can be used to obtain titles of the books which the user is interested in.

As described previously, in this step S704, applicable facets, metadata under each facet, and relationships, for example, may be shown to the user.

For step S710, the search engine may combine the facet metadata constraint that the user has selected with the current query S to form a new query S′. The new constraint can be added to the WHERE clause of the query S. Suppose the current query S is in the form of:
SELECT ?x WHERE{ . . . },
   then the new query S′ may be:
SELECT ?x WHERE {?x ex:attr ?v. Q . . . },
   in which the facet metadata constraint consists of an attribute ex:attr and a SPARQL query condition Q, and in which ?v is a variable not in S and the variables in Q must be substituted by ?v.

For example, suppose the user selects the metadata constraint “<30” under the price facet under the current query S:
SELECT ?x WHERE {?x rdf:type ex:Book},
   then S′ may be:

SELECT ?x
WHERE { ?x ex:price ?v . FILTER (?v<30) . ?x rdf:type ex :Book}.

After the user selects the metadata constraint “<1980” under the publication time facet, the query may further change to:

SELECT ?x
WHERE { ?x ex:publication-time ?w . FILTER (?w<1980).
?x ex:price ?v . FILTER (?v<30).
?x rdf:type ex :Book }.

For step S707, given the current query S and the relationship ex:p which the user has selected, the search engine may construct a new query S′ that may obtain information resource instances that are connected to S via ex:p.

Since the current query S is in the form of:
SELECT ?x WHERE { . . . },
   then the new query S′ can be constructed as:
SELECT ?y WHERE {?x ex:p?y . . . }.

For example, if the current query S is:

SELECT ?x
WHERE { ?x ex:price ?v . FILTER (?v<30) . ?x rdf:type ex :Book},

and the user selects the ex:authoredBy relationship, then the new query S′ may be:

SELECT ?y
WHERE { ?x ex:authoredBy ?y .
?x ex:price ?v . FILTER (?v<30) .
?x rdf:type ex:Book }.

For step S708, the new query S′ constructed in step S707 may be input to recursively invoke XFACTED QUERY.

For step S709, according to the current query S, the relationship ex:p that the user has selected, and the result R returned from step S708, the search engine may construct a new query S′ that uses R to further constrain S.

For example, if S is:
SELECT ?x WHERE {X-CONDITIONS},

### and R is:

SELECT ?y WHERE {Y-CONDITIONS},
   then the new query S′ may be:

SELECT ?x
WHERE { ?x ex:p ?y . X-CONDITIONS . Y-CONDITIONS }.

Variables in Y-CONDITIONS need to be re-named if they also appear in X-CONDITIONS.

For example, if S is:

SELECT ?x
WHERE { ?x ex:price ?v . FILTER (?v<30) . ?x rdf:type ex :Book},

### and R is:

SELECT ?y
WHERE { ?y ex:age ?v . FILTER ( ?v < 30 ) .
?x ex:authoredBy ?y .
?x ex:price ?v . FILTER (?v<30) .
?x rdf:type ex:Book },

then the new query S′ may be:

SELECT ?x
WHERE {?x ex:authoredBy ?y .
?x ex:price ?v . FILTER (?v<30) .
?x rdf:type ex:Book .
?y ex:age ?w . FILTER ( ?w < 30 ) }.

For step S711, the search engine may simply use the new query constructed in either step S709 or step S710 to replace the current query. In other words, the search engine may set S=S′.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It should be understood, of course, that the foregoing relates to exemplary embodiments of the invention and that modifications may be made without departing from the spirit and scope of the invention as set forth in the following claims.

We claim:

1. A method for the searching of information resources, comprising the steps of:
according to a current query for a first type of information resource, obtaining a result of query on said first type of information resource, one or more facets of said first type of information resource and metadata under each facet, and relationships between said first type of information resource and other types of information resource that at least include a second type of information resource; and
returning to a user the obtained result of query on said first type of information resource, the one or more facets of said first type of information resource and the metadata under each facet, and the relationships between said first type of information resource and other types of information resource that at least include a second type of information resource.

2. The method according to claim 1, further comprising the steps of:
determining that the user has selected returned metadata under a facet of said first type of information resource;
combining the current query for the first type of information resource with the selected metadata under a facet of said first type of information resource, to form a new query for the first type of information resource; and
treating said new query for the first type of information resource as the current query for the first type of information resource to once more obtain and return a result of query on said first type of information resource, one or more facets of said first type of information resource and metadata under each facet, and relationships between said first type of information resource and other types of information resource that at least include a second type of information resource.

3. The method according to claim 1, further comprising the steps of:
determining that the user has selected a returned relationship with said second type of information resource;
constructing a current query for the second type of information resource according to the current query for the first type of information resource and the selected relationship with said second type of information resource;
according to the current query for the second type of information resource, obtaining a result of query on said second type of information resource and one or more facets of said second type of information resource and metadata under each facet; and
returning to the user the obtained result of query on said second type of information resource and the one or more facets of said second type of information resource and the metadata under each facet.

4. The method according to claim 3, further comprising the steps of:
determining that the user has selected a returned metadata under a facet of said second type of information resource;
combining the current query for the second type of information resource with the selected metadata under a facet of said second type of information resource, to form a new query for the second type of information resource; and
treating said new query for the second type of information resource as the current query for the second type of information resource to once more obtain and return a result of query on said second type of information resource and one or more facets of said second type of information resource and metadata under each facet.

5. The method according to claim 4, further comprising the steps of:
determining that the once more returned result of query on said second type of information resource is the query result which the user wants;
combining the current query for the first type of information resource with the current query for the second type of information resource, which leads to the once more return, to form a new query for the first type of information resource; and
treating said new query for the first type of information resource as the current query for the first type of information resource to once more obtain and return a result of query on said first type of information resource, one or more facets of said first type of information resource and metadata under each facet, and relationships between said first type of information resource and other types of information resource that exclude said second type of information resource.

6. An apparatus for the searching of information resources, comprising:
means for, according to a current query for a first type of information resource, obtaining a result of query on said first type of information resource, one or more facets of said first type of information resource and metadata under each facet, and relationships between said first type of information resource and other types of information resource that at least include a second type of information resource; and
means for returning to a user the obtained result of query on said first type of information resource, the one or more facets of said first type of information resource and the metadata under each facet, and the relationships between said first type of information resource and other types of information resource that at least include a second type of information resource.

7. The apparatus according to claim 6, further comprising:
means for determining that the user has selected returned metadata under a facet of said first type of information resource;
means for combining the current query for the first type of information resource with the selected metadata under a facet of said first type of information resource, to form a new query for the first type of information resource; and
means for treating said new query for the first type of information resource as the current query for the first type of information resource to once more obtain and return a result of query on said first type of information resource, one or more facets of said first type of information resource and metadata under each facet, and relationships between said first type of information resource and other types of information resource that at least include a second type of information resource.

8. The apparatus according to claim 6, further comprising:
means for determining that the user has selected a returned relationship with said second type of information resource;
means for constructing a current query for the second type of information resource according to the current query for the first type of information resource and the selected relationship with said second type of information resource;
means for, according to the current query for the second type of information resource, obtaining a result of query on said second type of information resource and one or more facets of said second type of information resource and metadata under each facet; and
means for returning to the user the obtained result of query on said second type of information resource and the one or more facets of said second type of information resource and the metadata under each facet.

9. The apparatus according to claim 8, further comprising:
means for determining that the user has selected returned metadata under a facet of said second type of information resource;
means for combining the current query for the second type of information resource with the selected metadata under a facet of said second type of information resource, to form a new query for the second type of information resource; and
means for treating said new query for the second type of information resource as the current query for the second type of information resource to once more obtain and return a result of query on said second type of information resource and one or more facets of said second type of information resource and metadata under each facet.

10. The apparatus according to claim 9, further comprising:
means for determining that the once more returned result of query on said second type of information resource is the query result which the user wants;
means for combining the current query for the first type of information resource with the current query for the second type of information resource, which leads to the once more return, to form a new query for the first type of information resource; and
means for treating said new query for the first type of information resource as the current query for the first type of information resource to once more obtain and return a result of query on said first type of information resource, one or more facets of said first type of information resource and metadata under each facet, and relationships between said first type of information resource and other types of information resource that exclude said second type of information resource.
